(19) United States
(12) Patent Application Publication
(10) Pub. No.: US 2016/0277823 A1
(43) Pub. Date: Sep. 22, 2016

(54) PIEZOELECTRIC CERAMIC DUAL-BAND BASS-ENHANCED EARPIECE

(71) Applicant: Jetvox Acoustic Corp., Taoyuan (TW)

(72) Inventors: To-Teng HUANG, Taoyuan (TW); Ming-Fang HUNG, Taoyuan (TW)

(21) Appl. No.: 14/725,380

(22) Filed: May 29, 2015

(30) Foreign Application Priority Data
Mar. 20, 2015 (TW) 104204273

(51) Int. Cl. H04R 1/10; H04R 9/02; H04R 17/00

(52) U.S. Cl. CPC H04R 1/1016; H04R 17/00; H04R 9/02

(57) ABSTRACT

A piezoelectric ceramic dual-band bass-enhanced earpiece includes an earphone shell, a moving coil speaker assembly and a piezoelectric ceramic speaker component. The earphone shell includes an acoustic output orifice. The moving coil speaker assembly includes a moving coil speaker and a circuit connecting unit electrically connected to the moving coil speaker. The piezoelectric ceramic speaker component is located between the acoustic output orifice and moving coil speaker assembly and includes a piezoelectric ceramic plate and a conductive member connecting to the piezoelectric ceramic plate and the circuit connecting unit. The piezoelectric ceramic plate includes a plurality of acoustic through orifices. With the combination of the piezoelectric ceramic speaker component and moving coil speaker assembly, the piezoelectric ceramic dual-band bass-enhanced earpiece achieves the hearing effect that high-frequency sound wave surrounded by low-frequency sound wave. Due to increasing high-frequency resolution, the user can feel the improvement of bass frequency effect.

### CROSS-REFERENCES TO RELATED APPLICATIONS

This non-provisional application claims priority under 35 U.S.C. §119(a) on Patent Application No. 104204273 filed in Taiwan, R.O.C. on 2015 Mar. 20, the entire contents of which are hereby incorporated by reference.

### BACKGROUND

1. Technical Field

The instant disclosure relates to the field of earpiece audio, in particular, to a combination of piezoelectric ceramic speaker component and a moving coil speaker assembly, which is an earpiece structure for increasing high-frequency resolution and improving of bass frequency.

2. Related Art

Most of earpieces cooperated with cell phone, tablet PC, mp3 player and other consumer electronic products are moving coil earpieces. Basically, the moving coil earpiece makes use of the circular cylinder coil in a permanent magnetic field, namely, the voice coil is connected to a diaphragm. In the current signal driving, the voice coil generates a magnetic field and interacts with the magnetic field to make the diaphragm to vibrate. The audio signal is transmitted to the voice coil to convert to the audio sound wave for outputting through the audio cable.

In general, for generic and cost consideration, the diaphragm is usually adopted for resolving full-frequency sound waves. The advantage is to produce a wider frequency band. However, the resolution of the high-frequency and the low-frequency are relatively low so that the voice, the position of response, and the stereo spaciousness do not be resolved clearly.

Since the number of the game programs of the cell phone and tablet PC increases, the player requires improving the audio resolution of the earpiece and expects the improvement of bass frequency effect. In order to meet the needs, the bass voice coil is combined with treble voice coil currently. However, the vibration is predominantly dominated by the diaphragm so that the audio resolution is still not clearly. Therefore, hoping to solve the above problems and achieve increasing specific frequency resolution and improve of bass frequency effect.

### SUMMARY

To address the above issue, the instant disclosure provides a piezoelectric ceramic dual-band bass-enhanced earpiece. The earpiece comprises an earphone shell, a moving coil speaker assembly and a piezoelectric ceramic speaker component. The earphone shell includes an acoustic output orifice. The moving coil speaker assembly is disposed in the earphone shell and comprises a moving coil speaker and a circuit connecting unit. The circuit connecting unit is electrically connected to the moving coil speaker. The piezoelectric ceramic speaker component is disposed in the earphone shell and located between the acoustic output orifice and moving coil speaker assembly. The piezoelectric ceramic speaker component comprises a piezoelectric ceramic plate and a conductive member connecting to the piezoelectric ceramic plate and the circuit connecting unit. The piezoelectric ceramic plate comprises a plurality of acoustic through orifices.

In one embodiment of the present disclosure, the moving coil speaker assembly and the piezoelectric ceramic speaker component are disposed in the earphone shell through a trestle frame. The earphone shell comprises an acoustic output orifice. A moving coil speaker of the moving coil speaker assembly is connected to a first side of the trestle frame, and the piezoelectric ceramic plate connected to a second side of the trestle frame. The second side is opposite to the first side and toward the acoustic output orifice.

In one embodiment of the present disclosure, the earphone shell includes a first shield member and a second shield member. The first shield member and the second shield member are combined to form a receiving space, and the trestle frame is connected to the first shield member or the second shield member.

In one embodiment of the present disclosure, the piezoelectric ceramic dual-band bass-enhanced earpiece further comprises a dust gauze. The dust gauze is located between the first shield member and the piezoelectric ceramic speaker component and is corresponding to the acoustic output orifice so as to prevent the function of elements from influencing by the dust.

In one embodiment of the present disclosure, the piezoelectric ceramic speaker component is connected to the trestle frame through an adhesive sheet.

In one embodiment of the present disclosure, the piezoelectric ceramic dual-band bass-enhanced earpiece further comprises a buffer material. The buffer material disposed on at least one surface of the piezoelectric ceramic speaker component to adjust the frequency produced from the piezoelectric ceramic speaker component.

In one embodiment of the present disclosure, the piezoelectric ceramic plate is a complex piezoelectric ceramic board, and the complex piezoelectric ceramic board includes a metal plate and a ceramic membrane. The ceramic membrane is disposed on a surface of the metal plate, and the acoustic through orifices pass through the metal plate and the ceramic membrane.

In one embodiment of the present disclosure, the moving coil speaker includes a diaphragm, a voice coil, a circular magnet, a washer, a yoke component and a fixing seat. The diaphragm is toward to the acoustic output orifice. The voice coil is disposed on the lower surface of the diaphragm. The washer is disposed on the surface of the circular magnet. The yoke component engages with the first shield member or the second shield member, and the circular magnet is disposed in the yoke component. The fixing seat is disposed on the yoke component to fix the diaphragm.

Furthermore, the moving coil speaker includes an acoustic guiding member disposed in the center of the circular magnet and the washer. The acoustic guiding member has a guiding orifice corresponding to the center of the diaphragm.

The piezoelectric ceramic dual-band bass-enhanced earpiece is a combination of the piezoelectric ceramic speaker component and the moving coil speaker assembly to achieve the hearing effect that high-frequency sound wave is surrounded by low-frequency sound wave. The piezoelectric ceramic speaker component can produce sounds with high frequency, and the moving coil speaker assembly can produce sounds with full frequency. In addition to the improve the high frequency resolution, the user can hear the improvement of bass frequency effect. Therefore, the conventional technical problems of single speaker unit can be solved.

### BRIEF DESCRIPTION OF THE DRAWINGS

FIG. 1 is an exploded view of a piezoelectric ceramic dual-band bass-enhanced earpiece of the instant disclosure.

FIG. 2 is a cross-sectional of a piezoelectric ceramic dual-band bass-enhanced earpiece of the instant disclosure.

FIG. 3 is an exploded view of a moving coil speaker assembly of the instant disclosure.

FIGS. 4A and 4B are cross-sectional view of a piezoelectric ceramic dual-band bass-enhanced earpiece in accordance with each embodiment of the present disclosure.

### DETAILED DESCRIPTION

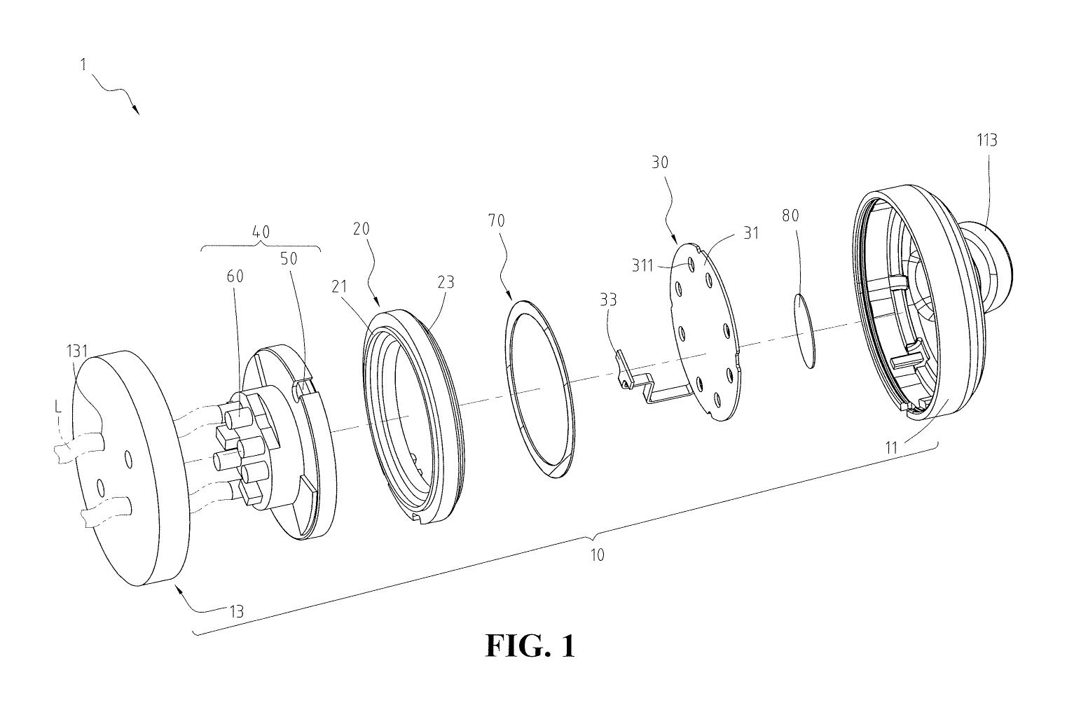

Please refer to FIG. 1. FIG. 1 is an exploded view of a piezoelectric ceramic dual-band bass-enhanced earpiece of the instant disclosure. As shown in FIG. 1, the piezoelectric ceramic dual-band bass-enhanced earpiece includes an earphone shell 10, a piezoelectric ceramic speaker component 30 and a moving coil speaker assembly 40. In the embodiment shown in FIG. 1, the earphone shell 10 includes a first shield member 11 and a second shield member 13. The first shield member 11 and the second shield member 13 are combined to form a receiving space 15. The first shield member 11 has an in-ear portion 111 for cooperating the auditory meatus of the wearer. The in-ear portion 111 has at least one acoustic output orifice 113.

The piezoelectric ceramic speaker component 30 and the moving coil speaker assembly 40 are disposed in the receiving space 15. The piezoelectric ceramic speaker component 30 is located between the acoustic output orifice 113 and the moving coil speaker assembly 40. The moving coil speaker assembly 40 includes a moving coil speaker 50 and a circuit connecting unit 60. The circuit connecting unit 60 is electrically connected to the moving coil speaker 50. The piezoelectric ceramic speaker component 30 is disposed in the receiving space 15 and includes a piezoelectric ceramic plate 31 and a conductive member 33. The conductive member 33 is connecting to the piezoelectric ceramic plate 31 and circuit connecting unit 60, so that the piezoelectric ceramic plate 31 is electrically connected to the circuit connecting unit 60.

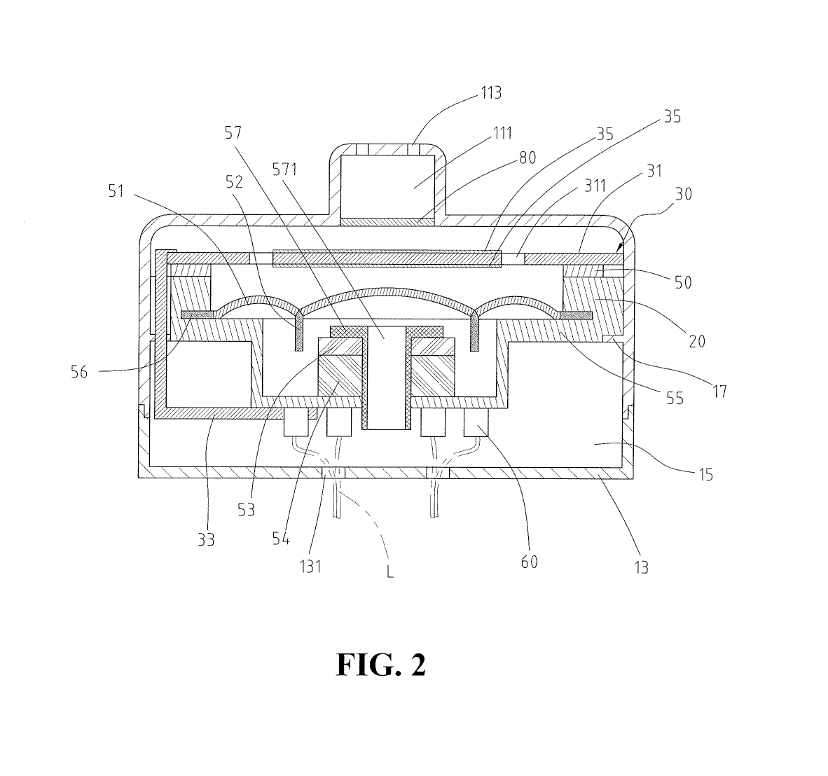

FIG. 2 is a cross-section view of a piezoelectric ceramic dual-band bass-enhanced earpiece of the instant disclosure. Please refer to FIGS. 1 and 2 simultaneously. The piezoelectric ceramic speaker component 30 and the moving coil speaker assembly 40 are disposed in the receiving space 15 through a trestle frame 20. The trestle frame 20 can engage with the first shield member 11 through a tenon 17, however, this is only an example. In practical, the trestle frame 20 can be connected to the first shield member 11 or the second shield member 13. Or, the outer wall of the trestle frame 20 can engage with the first shield member 11 or the second shield member 13. Or, the trestle frame 20 can be screwed to the first shield member 11 or the second shield member 13 through the screw threads. The moving coil speaker 50 is connected to a first side 21 of the trestle frame 20. The piezoelectric ceramic plate 31 is connected to a second side 23 of the trestle frame 20, and the second side 23 is opposite to the first side 21 and toward the acoustic output orifice 113 of the first shield member 11. Besides, an audio cable L passes through the opening 131 and is connected to circuit connecting unit 60. However, the structure and shape of the earphone shell 10 and the assembly way of the piezoelectric ceramic speaker component 30 and the moving coil speaker assembly 40 are merely provided for example and illustration, without any intention to be used for limiting the present disclosure.

Furthermore, the piezoelectric ceramic speaker component 30 is connected to the second side 23 of the trestle frame 20 through an adhesive sheet 70. Moreover, as shown in FIGS. 1 and 2, the piezoelectric ceramic dual-band bass-enhanced earpiece includes a dust gauze 80. The dust gauze 80 is disposed between the first shield member 11 and the piezoelectric ceramic speaker component 30 and is corresponding to at least one acoustic output orifice 113. The dust gauze 80 is mainly used to avoid the dust falling to the acoustic output orifice 113 so as to prevent the function of the piezoelectric ceramic speaker component 30 and the moving coil speaker assembly 40 from influencing by the dust.

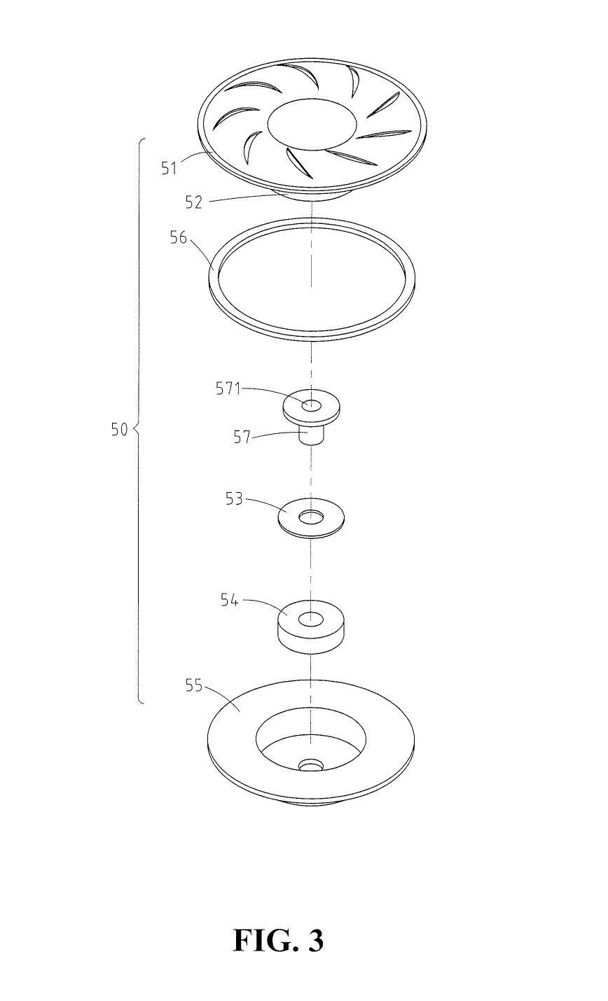

FIG. 3 is an exploded view of a moving coil speaker assembly of the instant disclosure. Please refer to FIGS. 2 and 3. The moving coil speaker 50 includes a diaphragm 51, a voice coil 52, a washer 53, a circular magnet 54, a yoke component 55 and a fixing seat 56. The diaphragm 51 is toward to the acoustic output orifice 113. The voice coil 52 is disposed on the lower surface of the diaphragm 51. The washer 53 is disposed on the surface of the circular magnet 54. When the voice coil 52 receives the electrical signal to produce electromagnetic field, the voice coil 52 generates electromagnetic interaction with the washer 53 and the circular magnet 54. The yoke component 55 engages with the earphone shell 10, such as the first shield member 11 or the second shield member 13, and the circular magnet 54 is disposed in the yoke component 55. The fixing seat 56 is disposed on the yoke component 55 to fix the diaphragm 51. The moving coil speaker 50 further includes an acoustic guiding member 57. The washer 53 and the circular magnet 54 are sleeve-connected to the acoustic guiding member 57. The acoustic guiding member 57 has a guiding orifice 571. The guiding orifice 571 is corresponding to the diaphragm 51 and toward to acoustic output orifice. The low-frequency sound wave produced by the moving coil speaker 50 can transmit to the in-ear portion 111.

Furthermore, as shown in FIG. 2, a buffer material 35 is disposed on at least one surface of the piezoelectric ceramic speaker component 30. The buffer material 35 can be made of ceramic, metal, or polymer material to adjust the frequency produced from the piezoelectric ceramic speaker component 30.

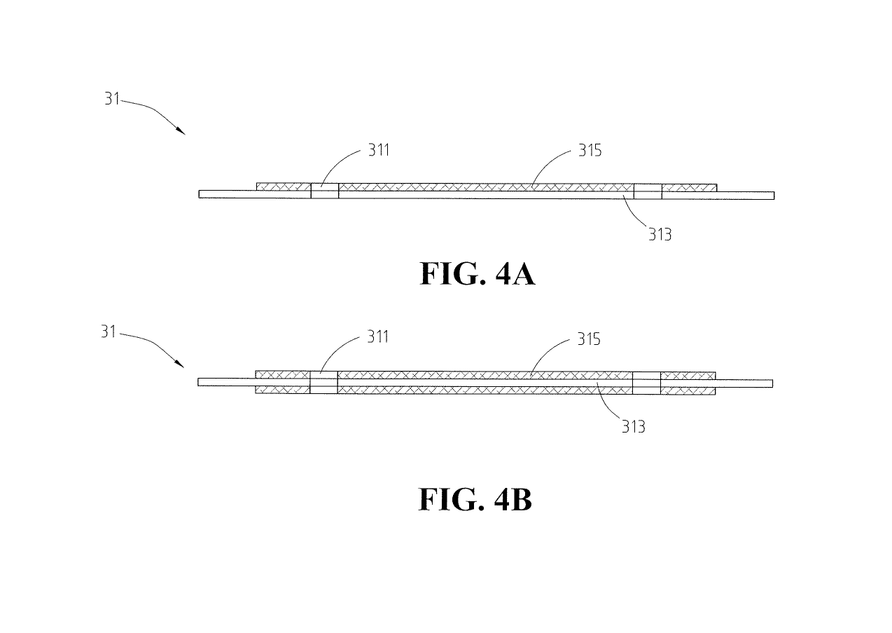

FIGS. 4A and 4B are an exploded view of a piezoelectric ceramic dual-band bass-enhanced earpiece of the instant disclosure. The piezoelectric ceramic plate 31 is a complex piezoelectric ceramic board. The complex piezoelectric ceramic board includes a metal plate 313 and the ceramic membrane 315 disposed on at least one surface of the metal plate 313. The high-frequency is produced by the vibration effect. Besides, the acoustic through orifices 311 pass through the metal plate 313 and the ceramic membranes 315.

With the combination of the piezoelectric ceramic speaker component and the moving coil speaker assembly, the piezoelectric ceramic speaker component can produce sounds with high frequency and the moving coil speaker assembly can produce sounds with full frequency so as to achieves the hearing effect that high-frequency sound wave is surrounded by low-frequency sound wave. In addition to the improvement of the high frequency resolution, the user can hear the improvement of bass frequency effect.

While the instant disclosure has been described by way of example and in terms of the preferred embodiments, it is to be understood that the invention needs not be limited to the disclosed embodiments. For anyone skilled in the art, various modifications and improvements within the spirit of the instant disclosure are covered under the scope of the instant disclosure. The covered scope of the instant disclosure is based on the appended claims.

What is claimed is:

1. A piezoelectric ceramic dual-band bass-enhanced earpiece, comprising:
an earphone shell comprising an acoustic output orifice;
a moving coil speaker assembly disposed in the earphone shell and comprising a moving coil speaker and a circuit connecting unit, the circuit connecting unit electrically connected to the moving coil speaker; and
a piezoelectric ceramic speaker component disposed in the earphone shell and located between the acoustic output orifice and moving coil speaker assembly, the piezoelectric ceramic speaker component comprising a piezoelectric ceramic plate and a conductive member connecting to the piezoelectric ceramic plate and the circuit connecting unit, the piezoelectric ceramic plate comprising a plurality of acoustic through orifices.

2. The piezoelectric ceramic dual-band bass-enhanced earpiece of claim 1, further comprising:
a trestle frame disposed in the earphone shell and connected to thereof, the moving coil speaker connected to a first side of the trestle frame, the piezoelectric ceramic plate connected to a second side of the trestle frame, the second side being opposite to the first side and toward the acoustic output orifice.

3. The piezoelectric ceramic dual-band bass-enhanced earpiece of claim 2, wherein the earphone shell includes a first shield member and a second shield member, the first shield member and the second shield member are combined to form a receiving space, the trestle frame is connected to the first shield member or the second shield member.

4. The piezoelectric ceramic dual-band bass-enhanced earpiece of claim 3, further comprising:
a dust gauze being located between the first shield member and the piezoelectric ceramic speaker component and being corresponding to the acoustic output orifice.

5. The piezoelectric ceramic dual-band bass-enhanced earpiece of claim 2, wherein the piezoelectric ceramic speaker component is connected to the trestle frame through an adhesive sheet.

6. The piezoelectric ceramic dual-band bass-enhanced earpiece of claim 1, wherein the piezoelectric ceramic plate is a complex piezoelectric ceramic board, the complex piezoelectric ceramic board includes a metal plate and a ceramic membrane disposed on a surface of the metal plate, the acoustic through orifices pass through the metal plate and the ceramic membrane.

7. The piezoelectric ceramic dual-band bass-enhanced earpiece of claim 1, wherein the piezoelectric ceramic plate is a complex piezoelectric ceramic board, the complex piezoelectric ceramic board includes a metal plate and two ceramic membranes, the ceramic membranes are disposed on a upper surface and a lower surface of the metal plate, the acoustic through orifices pass through the metal plate and the ceramic membranes.

8. The piezoelectric ceramic dual-band bass-enhanced earpiece of claim 1, further comprising:
a buffer material disposed on at least one surface of the piezoelectric ceramic speaker component to adjust the frequency produced from the piezoelectric ceramic speaker component.

9. The piezoelectric ceramic dual-band bass-enhanced earpiece of claim 1, wherein the moving coil speaker includes a diaphragm, a voice coil, a circular magnet, a washer, a yoke component and a fixing seat, the diaphragm is toward to the acoustic output orifice, the voice coil is disposed on the lower surface of the diaphragm, the washer is disposed on the surface of the circular magnet, the yoke component engages with the earphone shell, the circular magnet is disposed in the yoke component, the fixing seat is disposed on the yoke component to fix the diaphragm.

10. The piezoelectric ceramic dual-band bass-enhanced earpiece of claim 9, wherein the moving coil speaker includes an acoustic guiding member disposed in the center of the circular magnet and the washer, the acoustic guiding member having a guiding orifice corresponding to the center of the diaphragm.
